(19) United States
(12) Patent Application Publication
(10) Pub. No.: US 2009/0250836 A1
(43) Pub. Date: Oct. 8, 2009

(54) Production Method for Molded Coil

(75) Inventor: Yoshizumi FUKUI, Hiki-gun (JP)

Correspondence Address: COHEN, PONTANI, LIEBERMAN & PAVANE LLP, 551 FIFTH AVENUE, SUITE 1210, NEW YORK, NY, 10176, US

(73) Assignee: Toko, Inc., Tokyo (JP)

(21) Appl. No.: 12/418,347

(22) Filed: Apr. 3, 2009

(30) Foreign Application Priority Data
Apr. 4, 2008 (JP) 2008-097874
Dec. 12, 2008 (JP) 2008-316567
Dec. 19, 2008 (JP) 2008-323400
Dec. 19, 2008 (JP) 2008-323401

(51) Int. Cl. B29C 45/14

(52) U.S. Cl. 264/272.15; 264/272.19

(57) ABSTRACT

Disclosed is a method oft by using a plastic molding process, encapsulating an air-core coil with a moldable magnetic resin material prepared by kneading a mixture of a magnetic powder and a resin. The method comprises the steps of (a) preparing a molding die assembly which includes a plurality of dies adapted to define a cavity therewithin, and a positioning pin adapted to be movable in a vertical or horizontal direction within the cavity, (b) arranging the air-core coil at a given position within the cavity by the positioning pin, (c) charging the moldable magnetic resin material into the cavity and moving the positioning pin to a given retracted position in a course of the charging.

### BACKGROUND OF THE INVENTION

1. Field of the Invention

The present invention relates to a production method for a molded coil, and more particularly to a method for encapsulating an air-core coil with a moldable magnetic resin material.

2. Description of the Background Art

Heretofore, a molded coil has been widely used which has a coil encapsulated with a moldable magnetic resin material prepared by kneading a mixture of a magnetic powder and a resin. A conventional molded coil production method comprises setting a coil wound around a magnetic core, such as a ferrite core, within a cavity of a die assembly, and then charging a moldable magnetic resin material in a molten state, into the cavity to encapsulate the coil therewith. JP 04-338613A and JP 2006-032847A disclose a molded coil production method using a magnetic core.

In the conventional molded coil production method, if it is tried to encapsulate an air-core coil with a moldable magnetic resin material in an independent state without using a magnetic core, various problems are likely to arise. For example, the air-core coil is likely to become deformed due to a charging pressure of the moldable magnetic resin material. Moreover, the air-core coil is likely to become deviated from an intended position due to displacement or inclination toward one side of the cavity. The deformation and positional deviation not only cause defective appearance but also have an impact on electric characteristics, such as an inductance value and DC superposition characteristics. Therefore, a magnetic core or a frame has been commonly used as a means to prevent the deformation and positional deviation of a coil.

Recent years, there has been significant technical innovation in downsizing and functional upgrading of electronic apparatuses. Under this circumstance, there has also been an increasing need for downsizing, performance upgrading and cost reduction in electronic components, such as a molded coil. However, the magnetic core or the frame used in conventional molded coils hinders a reduction in overall size or height dimension of a molded coil. Moreover, it also leads to an increase in cost.

In view of obtaining a higher inductance value in a molded coil, it is desirable to encapsulate a coil with a moldable magnetic resin material having a higher magnetic permeability Generally, in case of increasing a magnetic permeability of a moldable magnetic resin material, a content rate of a magnetic powder to the moldable magnetic resin material is increased. However, along with an increase in content rate of the magnetic powder, a viscosity and a specific gravity of the moldable magnetic resin material in a molten state become higher. Specifically, when the content rate of the magnetic powder is set at 60 volume % or more, the moldable magnetic resin material exhibits excellent magnetic characteristics. At the same time, the viscosity and the specific gravity thereof in a molten state are extremely increased. Thus, if such a moldable magnetic resin material is charged into a cavity of a molding die assembly, a high charging pressure will be applied to a coil.

Further, in cases where it is tried to obtain a molded coil having a higher inductance value while reducing in size thereof, it is necessary to prepare a coil using a thinner wire in order to ensure a required number of turns. In a process of encapsulating an air-core coil formed of such a thin wire, with a moldable magnetic resin material, a charging pressure from the moldable magnetic resin material gives rise to problems, such as deformation and positional deviation of the air-core coil. The deformation in this process means the concurrence of distortion or disarrangement in the air-core coil, or breaking of the wire in the worst case.

As measures against such problems, the applicant of this application proposed a molding method comprising the steps of: a) charging a moldable magnetic resin material into respective cavities provided in an upper die and a lower die, and b) sandwichingly encapsulating an air-core coil with the moldable magnetic resin material charged within the cavities of the upper and lower dies in a molten state, in the previously filed Japanese Patent Application No. 2008-004005. This method can control a variation in encapsulated position of an air-core coil to some degree. However, in order to ensure stable quality of molded products, it is essential to control a flow of the moldable magnetic resin material charged in the upper and lower dies. Moreover, this method involves complexity in process and equipment, and thereby there remains a need for further improvement in terms of cost and mass productivity

### SUMMARY OF THE INVENTION

It is an object of the present invention to provide a method capable of producing a downsized molded coil at a low production cost with excellent mass productivity.

In order to achieve this object, according to a first aspect of the present invention, there is provided a method of producing, using a plastic molding process, a molded coil which has an air-core coil encapsulated with a moldable magnetic resin material prepared by kneading a mixture of a magnetic powder and a resin. The method comprises the steps of: preparing a molding die assembly which includes a plurality of dies adapted to define a cavity therewithin, a positioning pin and a support pin, wherein each of the positioning pin and the support pin is adapted to be movable in a vertical direction within the cavity; setting the air-core coil within the cavity in such a manner that it is positionally fixed relative to the cavity in a horizontal direction by the positioning pin, and held in midair by the support pin; and charging the moldable magnetic resin material into the cavity and moving the positioning pin and the support pin to respective given retracted positions thereof in a course of the charging. According to a second aspect of the present invention, there is provided a method of producing, using a plastic molding process, a molded coil which has an air-core coil encapsulated with a moldable magnetic resin material having a magnetic powder dispersed thereover. The method comprises the steps of: attaching an external electrode to the air-core coil; preparing a molding die assembly which includes a plurality of dies adapted to define a cavity therewithin, and a positioning pin adapted to be movable in a vertical direction within the cavity; setting the air-core coil within the cavity in such a manner that it is positionally fixed relative to the cavity in a horizontal direction by the positioning pin, and held in midair by the external electrode; and charging the moldable magnetic resin material into the cavity and moving the positioning pin to a given retracted position thereof in a course of the charging.

According to a third aspect of the present invention, there is provided a method of producing, using a plastic molding process, a molded coil which has an air-core coil encapsulated with a moldable magnetic resin material prepared by kneading a mixture of a magnetic powder and a resin. The method comprises the steps of: preparing a molding die assembly which includes a plurality of dies adapted to define a cavity therewithin, and a positioning pin adapted to be movable in a horizontal direction within the cavity; setting the air-core coil at a given position within the cavity by use of the positioning pin; and charging the moldable magnetic resin material into the cavity and moving the positioning pin to a given retracted position thereof in a course of the charging.

As above, in the molded coil production method of the present invention, the molding die assembly is used which includes a plurality of dies adapted to define a cavity therewithin, and a positioning pin adapted to be movable in a vertical or horizontal direction within the cavity Thus, the air-core coil can be adequately set in an intended position within the cavity by the positioning pin.

In the molded coil production method of the present invention, the positioning pin is moved to the given retracted position thereof in the course of the charging of the moldable magnetic resin material into the cavity This makes it possible to encapsulate the air-core coil with the moldable magnetic resin material in a stepwise manner while keeping the air-core coil in the intended position.

In the molded coil production method of the present invention, an air-core coil having an inner peripheral surface with a non-generally circular shape may be used. In this case, the air-core coil can be kept from being rotated within the cavity. This makes it possible to more enhance positional accuracy of the air-core coil. The non-generally circular shape may be one selected from the group consisting of a semicircular shape, a sector shape, an oval shape, an elliptical shape, a generally polygonal shape, and any combination thereof.

In the molded coil production method of the present invention, even if the moldable magnetic resin material contains the magnetic powder in an amount of 60 volume % or more, deformation or positional deviation of the air-core coil is less likely to occur. This makes it possible to readily produce a molded coil with a high degree of molding accuracy

In the molded coil production method of the present invention, a molded coil can be produced using a compression molding process, as well as a transfer molding process or an injection molding process which has been commonly employed. The compression molding process makes it possible to reduce a material loss so as to achieve a lower production cost.

### BRIEF DESCRIPTION OF THE DRAWINGS

FIG. 1 is a perspective view showing a coil member for use in a molded coil production method according to a first embodiment of the present invention.

FIGS. 2(a) and 2(b) illustrate a molding die assembly for use in the method according to the first embodiment, wherein FIG. 2(a) is a top view, and FIG. 2(b) is a sectional view taken along the line A-A in FIG. 2(a).

FIGS. 3(a) to 3(f) are explanatory diagrams showing a process of the method according to the first embodiment.

FIG. 4 is a perspective view showing a molded coil produced by the method according to the first embodiment.

FIG. 5 is an explanatory diagram showing a molding die assembly designed for a transfer molding process in a molded coil production method according to a second embodiment of the present invention.

FIGS. 6(a) to 6(d) are explanatory diagrams showing a process of the method according to the second embodiment.

FIG. 7 is a perspective view showing an external electrode for use in a molded coil production method according to a third embodiment of the present invention.

FIG. 8 is a perspective view showing a coil member for use in the method according to the third embodiment.

FIGS. 9(a) and 9(b) illustrate a molding die assembly for use in the method according to the third embodiment, wherein FIG. 9(a) is a top view, and FIG. 9(b) is a sectional view taken along the line B-B in FIG. 9(a).

FIG. 10 is a top view showing an arrangement of the coil member in the method according to the third embodiment.

FIGS. 11(a) to 11(d) are explanatory diagrams showing a process of the method according to the third embodiment.

FIG. 12 is a perspective view showing a molded coil produced by the method according to the third embodiment.

FIG. 13 is a perspective view showing an air-core coil for use in a molded coil production method according to a fourth embodiment of the present invention.

FIGS. 14(a) and 14(b) illustrate a molding die assembly for use in the method according to the fourth embodiment, wherein FIG. 14(a) is a top view, and FIG. 14(b) is a sectional view taken along the line C-C in FIG. 14(a).

FIG. 15 is a top view showing an arrangement of the air-core coil in the method according to the fourth embodiment.

FIG. 16 is a perspective view showing a molded coil produced by the method according to the fourth embodiment.

FIG. 17 is a perspective view showing an air-core coil for use in a molded coil production method according to a fifth embodiment of the present invention.

FIGS. 18(a) and 18(b) illustrate a molding die assembly for use in the method according to the fifth embodiment wherein FIG. 18(a) is a top view, and FIG. 18(b) is a front view.

FIGS. 19(a) and 19(b) are explanatory diagrams showing a process of the method according to the fifth embodiment.

FIGS. 20(a) and 20(b) are explanatory diagrams showing a process of the method according to the fifth embodiment.

FIG. 21 is an explanatory diagram showing a process of the method according to the fifth embodiment.

FIG. 22 is a perspective view showing a molded coil produced by the method according to the fifth embodiment.

FIGS. 23(a) and 23(b) illustrate a molding die assembly for use in a molded coil production method according to a sixth embodiment of the present invention, wherein FIG. 23(a) is a top view, and FIG. 23(b) is a front view.

FIGS. 24(a) and 24(b) are explanatory diagrams showing a process of the method according to the sixth embodiment.

FIGS. 25(a) to 25(c) are explanatory diagrams showing a process of the method according to the sixth embodiment.

FIGS. 26(a) and 26(b) illustrate a molding die assembly for use in a molded coil production method according to a seventh embodiment of the present invention, wherein FIG. 26(a) is a top view, and FIG. 26(b) is a front view.

FIGS. 27(a) to 27(c) are explanatory diagrams showing a process of the method according to the seventh embodiment.

FIG. 28 is a perspective view showing an air-core coil for use in a molded coil production method according to an eighth embodiment of the present invention.

FIGS. 29(a) and 29(b) illustrate a molding die assembly for use in the method according to the eighth embodiment wherein FIG. 29(a) is a top view, and FIG. 29(b) is a front view.

FIGS. 30(a) and 30(b) illustrate an arrangement of the air-core coil in the method according to the eighth embodiment, wherein FIG. 30(a) is a top view, and FIG. 30(b) is a front view.

### DESCRIPTION OF THE PREFERRED EMBODIMENTS

### First Embodiment

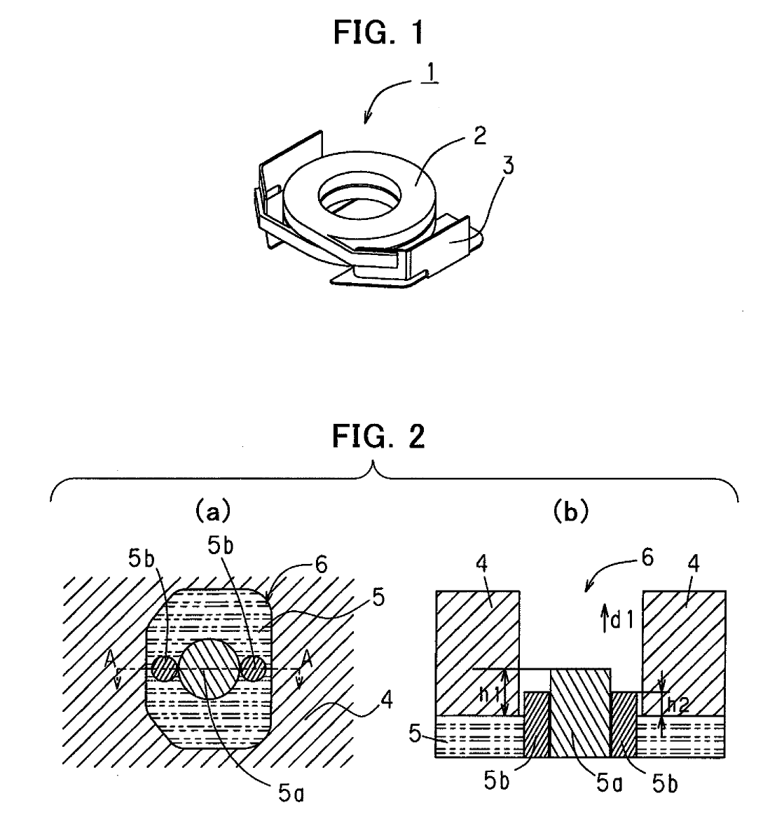

With reference to FIGS. 1 to 4, a molded coil production method according to a first embodiment of the present invention will be described.

A coil member for use in the method according to the first embodiment will first be described below. FIG. 1 is a perspective view showing a coil member 1 for use in the method according to the first embodiment. As shown in FIG. 1, the coil member 1 comprises an air-core coil 2 and an external electrode 3. The air-core coil 2 is formed using a self-bonding rectangular wire having a width of 0.25 mm and a thickness of 0.06 mm. The air-core coil 2 is obtained by using a core having a diameter of 1.0 mm, and by winding the rectangular wire swirlingly by 12 turns in two stages. The air-core coil 2 is formed such that both ends become outermost peripheries. Then, the air-core coil 2 is spot-welded to the external electrode 3 to obtain the coil member 1 illustrated in FIG. 1. The external electrode 3 may be made of phosphor bronze or electrolytic metal foil.

A molding die assembly for use in the method according to the first embodiment will be described below. FIGS. 2(a) and 2(b) illustrate a molding die assembly for use in the method according to the first embodiment, wherein FIG. 2(a) is a top view, and FIG. 2(b) is a sectional view taken along the line A-A in FIG. 2(a). As shown in FIGS. 2(a) and 2(b), the molding die assembly for use in the method according to the first embodiment comprises an upper die 4 and a lower die 5. The upper die 4 and the lower die 5 are adapted to define a cavity 6 therewithin when they are combined together. The lower die 5 is adapted to define a bottom of the cavity 6 when it is combined with the upper die 4. The lower die 5 has a positioning pin 5a and two support pins 5b provided in the bottom of the cavity 6 in an arrangement as shown in FIG. 2(a). Each of the positioning pin Sa and the two support pins 5b is adapted to be protrudable from the bottom of the cavity 6 upwardly, i.e., toward an opening of the cavity 6 (in the direction indicated by the arrowed line d1 in FIG. 2(b)) and retractable downwardly (i.e., adapted to be movable within the cavity 6 in a vertical direction).

In the first embodiment, the positioning pin 5a is comprised of a columnar-shaped metal bar having a diameter of 0.97 mm. Further, each of the support pins 5b is comprised of a columnar-shaped metal bar having a diameter of 0.4 mm. An initial position of the positioning pin 5a is set such that an upper edge surface of the positioning pin 5a protrudes from the bottom of the cavity 6 to a height h1, specifically, of 0.75 mm. Further, an initial position of each of the support pins 5b is set such that an upper edge surface of each of the support pins 5b protrudes from the bottom of the cavity 6 to a height h2 (h2<h1), specifically, of 0.38 mm.

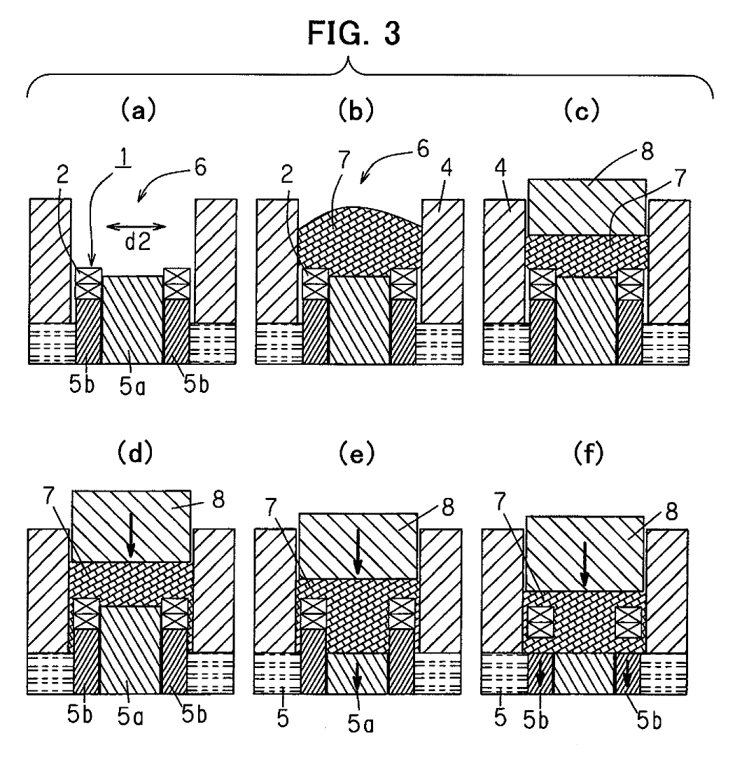

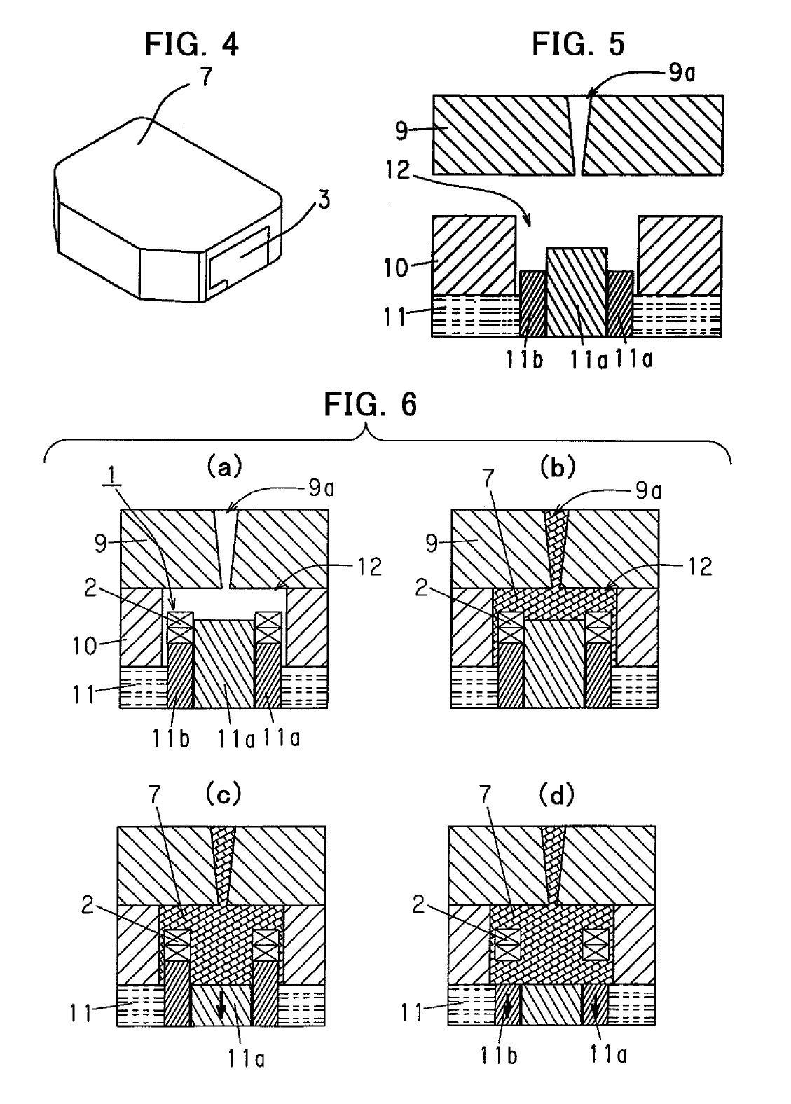

The molded coil production method according to the first embodiment will now be described. FIGS. 3(a) to 3(f) illustrate main steps of the method according to the first embodiment, wherein each of FIGS. 3(a) to 3(f) is a sectional view taken along the line A-A in FIG. 2(a). FIG. 4 is a perspective view showing a molded coil produced by the method according to the first embodiment.

In the first step illustrated in FIG. 3(a), the coil member 1 is set within the cavity 6, and then the molding die assembly is preheated at 180° C. Specifically, the coil member 1 is set in such a manner that the positioning pin 5a is inserted into a hollow space of the air-core coil 2 of the coil member 1, and a bottom surface of the air-core coil 2 is placed on the upper edge surfaces of the support pins 5b. Thus, the coil member 1 is positionally fixed relative to the cavity 6 in a horizontal direction (in the direction indicated by the arrowed line d2 in FIG. 3(a)) by the positioning pin 5a, and held in midair by the support pins 5b. In this state, the air-core coil 2 held in midair by the support pins 5b is preferably located at a height position higher than an encapsulated position of the air-core coil 2 within a molded coil after an after-mentioned molding process. The preheating may be performed at a temperature allowing an after-mentioned moldable magnetic resin material to be softened (i.e., at a temperature equal to or greater than a softening temperature of a resin contained in the after-mentioned moldable magnetic resin material). In the first embodiment, the preheating temperature is set at 180° C.

In the next step illustrated in FIG. 3(b), a given weighted amount of moldable magnetic resin material 7 is input from the opening of the upper die 4 into the cavity 6 to cover over the coil member 1, and the moldable magnetic resin material 7 is molten by heat of the preheated molding die assembly. In the first embodiment, the moldable magnetic resin material 7 is prepared by kneading a mixture of an amorphous alloy powder and a novolac-type epoxy resin to disperse the amorphous alloy powder over the novolac-type epoxy resin, cooling an obtained kneaded product, and pulverizing the cooled kneaded product into a powder form. A content rate of the amorphous alloy powder to the moldable magnetic resin material is set at 60 volume %.

In the next step illustrated in FIG. 3(c), a punch 8 is set at the opening of the upper die 4. In the next step illustrated in FIG. 3(d), the moldable magnetic resin material 7 is pressurized using the punch 8 to a pressure of 3 kgf for 5 seconds. In the next step illustrated in FIG. 3(e), the positioning pin 5a is moved downwardly to a retracted position where the upper edge surface thereof becomes flush with the bottom of the cavity 6, and then the moldable magnetic resin material 7 is pressurized using the punch 8 to a pressure of 5 kgf for 20 seconds. Through this step, the moldable magnetic resin material 7 is charged into a part of the cavity 6 which has been occupied by the positioning pin 5a. In the next step illustrated in FIG. 3(f), the pressurization by the punch 8 is interrupted to allow the punch 8 to be set in a free state, and, under this condition, each of the support pins 5b is moved downwardly to a retracted position where the upper edge surface thereof becomes flush with the bottom of the cavity 6, whereafter the moldable magnetic resin material 7 is re-pressurized using the punch 8 to a pressure of 10 kgf for 20 seconds. Through this step, the moldable magnetic resin material 7 is charged into a part of the cavity 6 which has been occupied by the support pins 5b. Subsequently the moldable magnetic resin material 7 is cured at 180° C. for 10 minutes.

A molded product obtained by curing the moldable magnetic resin material 7 is taken out of the molding die assembly. The molded product is subjected to sandblasting to remove burrs therefrom. In the above manner, a molded coil is produced in which at least a part of the external electrode 3 is exposed to a lateral surface and a bottom surface thereof, as shown in FIG. 4.

### Second Embodiment

With reference to FIGS. 5 and 6(d), a molded coil production method according to a second embodiment of the present invention will be described. The method according to the second embodiment is intended to produce a molded coil having the same configuration as that of the molded coil in the first embodiment, by a transfer molding process using the same coil member and moldable magnetic resin material as those used in the first embodiment. Thus, the method according to the second embodiment employs a common element to that in the first embodiment, and a detailed description about such a common element will be omitted.

A molding die assembly designed for a transfer molding process in the method according to the second embodiment will first be described below. FIG. 5 is a fragmentary sectional view showing a molding die assembly for use in the method according to the second embodiment. As shown in FIG. 5, the molding die assembly designed for a transfer molding process in the method according to the second embodiment comprises an upper die 9, an intermediate die 10 and a lower die 11. The upper die 9, the intermediate die 10 and the lower die 11 are adapted to define a cavity 12 therewithin when they are combined together. The upper die 9 is provided with a pin-point gate 9a. The pin-point gate 9a is adapted to allow the moldable magnetic resin material brought into a molten state in a chamber pot (not shown) to be charged into the cavity 12 therethrough. The lower die 11 is adapted to define a bottom of the cavity 12 when it is combined with the intermediate die 10, in the same relation as that between the upper and lower dies 4, 5 used in the first embodiment. The lower die 11 has a positioning pin 11a and two support pins 11b provided at respective given positions of the bottom of the cavity 12. Each of the positioning pin 11a and the two support pins 11b is adapted to be protrudable upwardly from the bottom of the cavity 12 and retractable downwardly (i.e., adapted to be movable within the cavity 12 in a vertical direction).

The molded coil production method according to the second embodiment will now be described. FIGS. 6(a) to 6(d) illustrate main steps of the method according to the second embodiment.

In the first step illustrated in FIG. 6(a), the coil member is set within the cavity 12, and then the molding die assembly is preheated at 180° C. after the upper die 9, the intermediate die 10 and the lower die 11 are fixed to each other. Specifically, the coil member is positionally fixed relative to the cavity 12 in a horizontal direction by the positioning pin 11a, and held in midair by the support pins 11b. This coil member is identical to the coil member 1 used in the first embodiment.

In the next step illustrated in FIG. 6(b), the moldable magnetic resin material 7 is injected from the pin-point gate 9a into the cavity 12 at a pressure of 100 kgf, and the pressure is held for 5 seconds. This moldable magnetic resin material 7 has the same composition as that of the moldable magnetic resin material used in the first embodiment.

In the next step illustrated in FIG. 6(c), the positioning pin 11a is moved downwardly to a retracted position where an upper edge surface thereof becomes flush with the bottom of the cavity 12, and then the moldable magnetic resin material 7 is pressurized to a pressure of 150 kgf and the pressure is held for 20 seconds. In the next step illustrated in FIG. 6(d), the pressurization is interrupted, and, under this condition, each of the support pins 11b is moved downwardly to a retracted position where an upper edge surface thereof becomes flush with the bottom of the cavity 12, whereafter the moldable magnetic resin material 7 is re-pressurized to a pressure of 200 kgf, and the pressure is held for 8 minutes to cure the moldable magnetic resin material 7.

A molded product obtained by curing the moldable magnetic resin material 7 is taken out of the molding die assembly. The molded product is subjected to sandblasting to remove burrs therefrom. In the above manner, the molded coil is produced.

### Third Embodiment

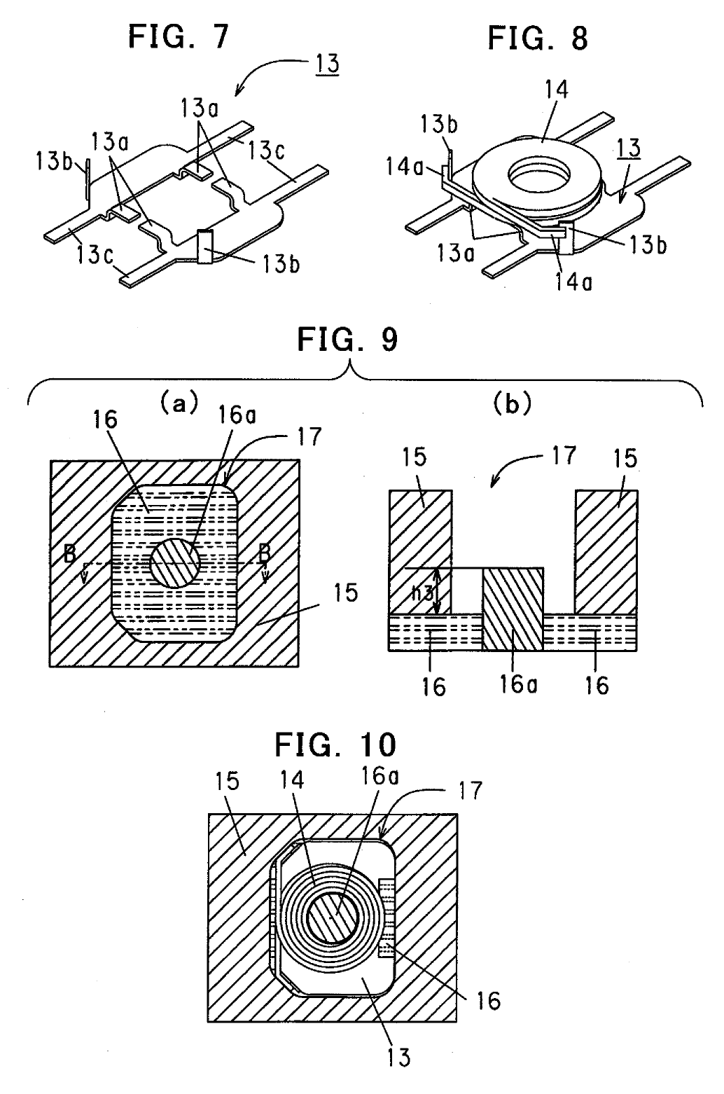

With reference to FIGS. 7 to 11(d), a molded coil production method according to a third embodiment of the present invention will be described. Differently from the first and second embodiments, the method according to the third embodiment employs a molding die assembly having only a positioning pin without any support pin. Further, the method according to the third embodiment is characterized in that an external electrode is attached to an air-core coil in such a manner as to allow the air-core coil to be held in midair within the molding die assembly. The method according to the third embodiment employs a common element to that in the first or second embodiment, and a detailed description about such a common element will be omitted.

A coil member for use in the method according to the third embodiment will first be described. FIG. 7 is a perspective view showing an external electrode for use in the method according to the third embodiment, and FIG. 8 is a perspective view showing the coil member for use in the method according to the third embodiment. As shown in FIG. 8, the coil member comprises an external electrode 13 and an air-core coil 14. In the third embodiment, the external electrode 13 is formed using a phosphor-bronze plate having a thickness of 0.1 mm, and fabricated in a shape having a support portion 13a, a connection portion 13b and an extension portion 13c, as shown in FIG. 7. Then, the air-core coil 14 is placed on the support portion 13a of the external electrode 13, and a terminal end 14a of the air-core coil 14 is spot-welded to the connection portion 13b of the external electrode 13 to obtain the coil member illustrated in FIG. 8. The air-core coil 14 is identical to the air-core coil used in the first and second embodiments.

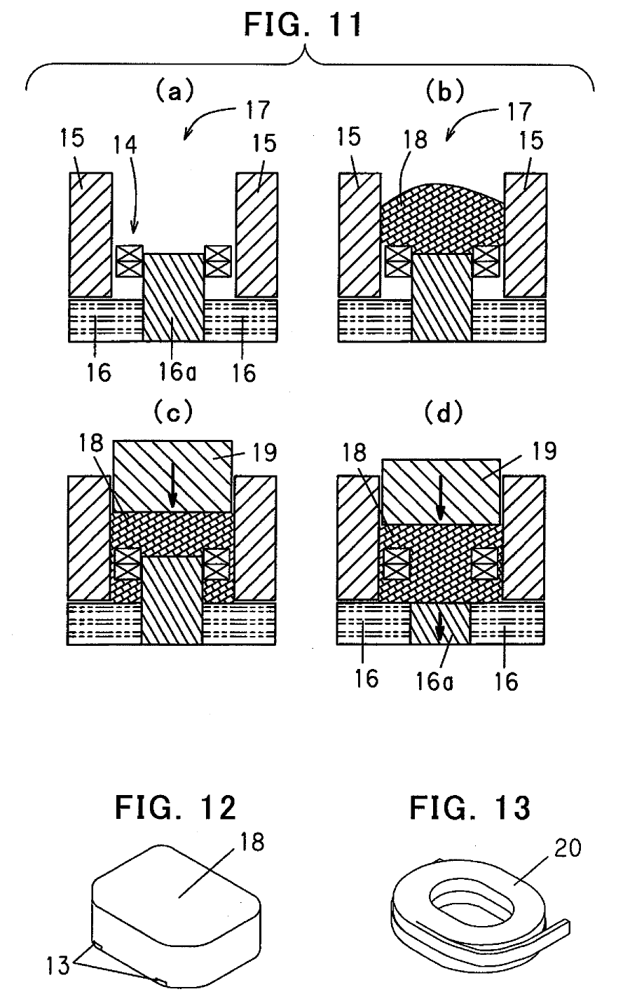

A molding die assembly designed for a compression molding process in the method according to the third embodiment will be described below. FIGS. 9(a) and 9(b) illustrate a molding die assembly for use in the method according to the third embodiment, wherein FIG. 9(a) is a top view, and FIG. 9(b) is a sectional view taken along the line B-B in FIG. 9(a). As shown in FIGS. 9(a) and 9(b), the molding die assembly for use in the method according to the third embodiment comprises an upper die 15 and a lower die 16. The upper die 15 and the lower die 16 are adapted to define a cavity 17 therewithin when they are combined together. The lower die 16 is adapted to define a bottom of the cavity 17 when it is combined with the upper die 15. The lower die 16 has a positioning pin 16a provided in the bottom of the cavity 17 in an arrangement as shown in FIG. 11(a). The positioning pin 16a is adapted to be protrudable from the bottom of the cavity 17 upwardly, i.e., toward an opening of the cavity 17 and retractable downwardly (i.e., adapted to be movable within the cavity 17 in a vertical direction). In the third embodiment, the positioning pin 16a is comprised of a columnar-shaped metal bar having a diameter of 0.97 mm. An initial position of the positioning pin 16a is set such that an upper edge surface of the positioning pin 16a protrudes from the bottom of the cavity 17 to a height h3, specifically, of 0.75 mm.

The molded coil production method according to the third embodiment will now be described. FIGS. 10 illustrates arrangement of the coil member according to the third embodiment. FIGS. 11(a) to 11(d) illustrate main steps of the method according to the third embodiment, wherein each of FIGS. 11(a) to 11(d) is a sectional view taken along the line B-B in FIG. 9(a). FIG. 12 is a perspective view showing a molded coil produced by the method according to the third embodiment.

In the first step illustrated in FIGS. 10 and 11(a), the coil member is set within the cavity 17, and then the molding die assembly is preheated at 180° C. Specifically, the coil member is set in such a manner that the extension portion 13c of the external electrode 13 is clamped between the upper die 15 and the lower die 16, and the positioning pin 16a is inserted into a hollow space of the air-core coil 14. Thus, the air-core coil 14 is positionally fixed relative to the cavity 17 in a horizontal direction by the positioning pin 16a, and held at an intended position in midair by the support portion 13a of the external electrode 13.

In the next step illustrated in FIG. 11(b), a given weighted amount of moldable magnetic resin material 18 is input from the opening of the upper die 15 into the cavity 17 to cover over the coil member, and the moldable magnetic resin material 18 is molten by heat of the preheated molding die assembly. In the third embodiment, the moldable magnetic resin material 18 has the same composition as that of the moldable magnetic resin material used in the first and second embodiments.

In the next step illustrated in FIG. 11(c), a punch 19 is set at the opening of the upper die 15, and the moldable magnetic resin material 18 is pressurized using the punch 19 to a pressure of 3 kgf for 5 seconds. In the next step illustrated in FIG. 11(d), the positioning pin 16a is moved downwardly to a retracted position where the upper edge surface thereof becomes flush with the bottom of the cavity 17, and then the moldable magnetic resin material 18 is pressurized using the punch 19 to a pressure of 5 kgf for 20 seconds. Through this step, the moldable magnetic resin material 18 is charged into a part of the cavity 17 which has been occupied by the positioning pin 16a. Subsequently, the pressurization by the punch 19 is interrupted to allow the punch 19 to be set in a free state, and, under this condition, the moldable magnetic resin material 18 is cured at 180° C. for 10 minutes.

A molded product obtained by curing the moldable magnetic resin material 18 is taken out of the molding die assembly. Then, a part of the extension portion 13c of the external electrode 13 exposed from the molded product is cut off. Further, the molded product is subjected to sandblasting to remove burrs therefrom. In the above manner, the molded coil illustrated in FIG. 12 is produced.

### Fourth Embodiment

With reference to FIGS. 13 to 16, a molded coil production method according to a fourth embodiment of the present invention will be described. Differently from the first to third embodiments, the method according to the fourth embodiment employs an air-core coil having a non-generally circular shape. A moldable magnetic resin material for use in the method according to the fourth embodiment has the same composition as that of the moldable magnetic resin material used in the first to third embodiments. Further, in the fourth embodiment, a molded coil is produced through the same process as that in the first embodiment. Thud, the method according to the fourth embodiment employs a common element or process to that in the first to third embodiments, and a detailed description about such a common element or process will be omitted.

An air-core coil for use in the method according to the fourth embodiment will first be described. FIG. 13 is a perspective view showing an air-core coil 20 for use in the method according to the fourth embodiment. The air-core coil 20 is formed using a self-bonding rectangular wire having a width of 0.25 mm and a thickness of 0.06 mm. The air-core coil 20 is obtained by using a core having an oval shaped cross section, and by winding the rectangular wire swirlingly by 12 turns in two stages. The air-core coil 20 is formed such that both ends become outermost peripheries.

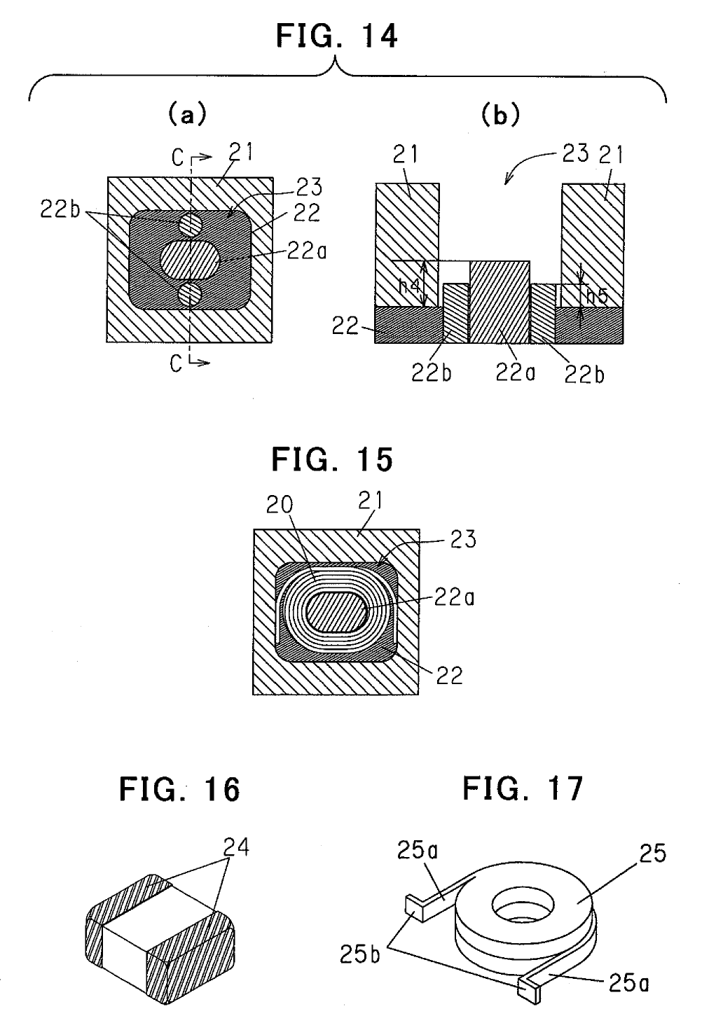

A molding die assembly for use in the method according to the fourth embodiment will be described below. FIGS. 14(a) and 14(b) illustrate a molding die assembly for use in the method according to the fourth embodiment, wherein FIG. 14(a) is a top view, and FIG. 14(b) is a sectional view taken along the line C-C in FIG. 14(a). As shown in FIGS. 14(a) and 14(b), the molding die assembly for use in the method according to the fourth embodiment comprises an upper die 21 and a lower die 22. The upper die 21 and the lower die 22 are adapted to define a cavity 23 therewithin when they are combined together. The lower die 22 is adapted to define a bottom of the cavity 23 when it is combined with the upper die 21. The lower die 22 has a positioning pin 22a and two support pins 22b provided in the bottom of the cavity 23. Each of the positioning pin 22a and the two support pins 22b is adapted to be protrudable from the bottom of the cavity 23 upwardly, i.e., toward an opening of the cavity 23 and retractable downwardly (i.e., adapted to be movable within the cavity 23 in a vertical direction).

In the fourth embodiment, the positioning pin 22a is comprised of a columnar-shaped metal bar having an oval shape in cross-section and a diameter less than that of the core member used in forming the air-core coil 20 by 20 μm. Further, each of the support pins 22b is comprised of a columnar-shaped metal bar having a diameter of 0.4 mm. An initial position of the positioning pin 22a is set such that an upper edge surface of the positioning pin 22a protrudes from the bottom of the cavity 23 to a height h4, specifically, of 0.75 mm. Further, an initial position of each of the support pins 22b is set such that an upper edge surface of each of the support pins 22b protrudes from the bottom of the cavity 23 to a height h5 (h5<h4), specifically, of 0.38 mm.

FIG. 15 is a top view showing an arrangement of the air-core coil in the method according to the fourth embodiment. After the air-core coil 20 is set within the cavity 23 as shown in FIG. 15, the air-core coil 20 is encapsulated with the moldable magnetic resin material through the steps described in the first embodiment. Then, the moldable magnetic resin material is cured to obtain a molded product and then the molded product is taken out of the molding die assembly The molded product is subjected to sandblasting to remove burrs therefrom and allow a terminal end of the air-core coil 20 to be exposed outside the molded product. Then, the molded product, except a portion for forming an external electrode, is coated with epoxy resin. Then, an external electrode 24 is formed by plating in such a manner that it is electrically connected to the exposed terminal end of the air-core coil 20. In the above manner, a molded coil as shown in FIG. 16 is produced.

### Fifth Embodiment

With reference to FIGS. 17 to 22, a molded coil production method according to a fifth embodiment of the present invention will be described. Differently from the first to fourth embodiments, the method according to the fifth embodiment employs a molding die assembly having a positioning pin adapted to be moved within a cavity in a horizontal direction. The method according to the fifth embodiment employs a common element to that in the first to fourth embodiments, and a detailed description about such a common element will be omitted.

An air-core coil for use in the method according to the fifth embodiment will first be described. FIG. 17 is a perspective view showing an air-core coil 25 for use in the method according to the fifth embodiment. The air-core coil 25 is formed using a self-bonding rectangular wire having a width of 0.25 mm and a thickness of 0.06 mm. Specifically, the air-core coil 25 is formed by winding the rectangular wire by 12 turns in a lap winding manner through the use of a core member having a core diameter of 1.0 mm, extending a pair of lead-out portions 25a in the same direction, and bending respective terminal ends of the lead-out portions 25a to form a pair of bent ends 25b, as shown in FIG. 17.

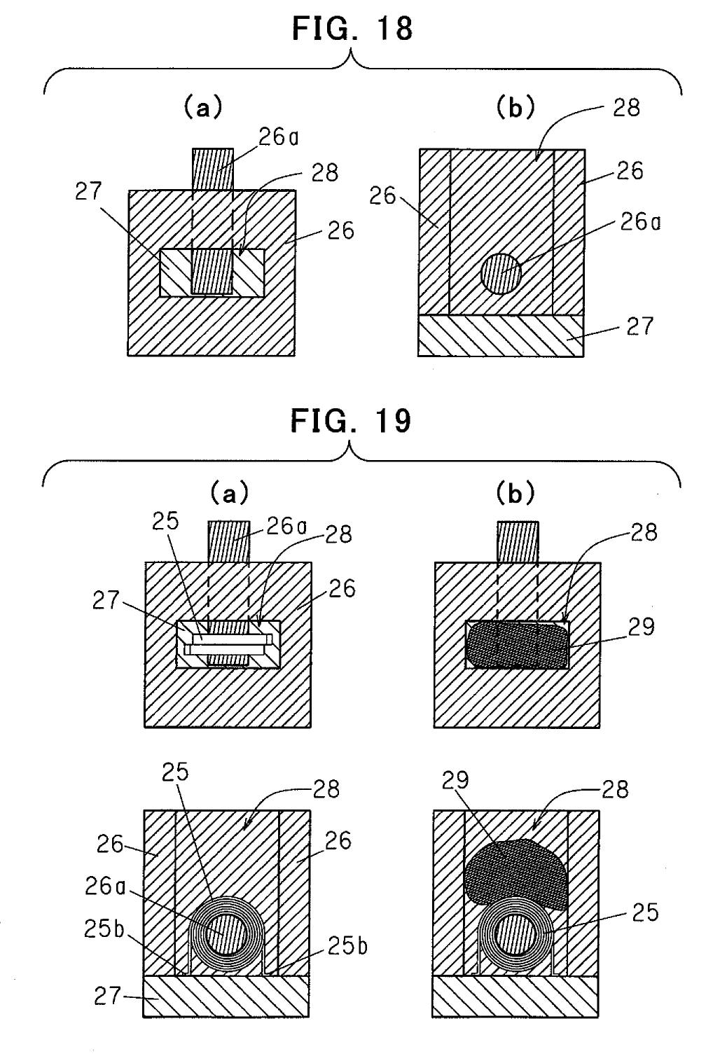

A molding die assembly for use in the method according to the fifth embodiment will be described below. FIGS. 18(a) and 18(b) illustrate a molding die assembly designed for a compression molding process in the method according to the fifth embodiment, wherein FIG. 18(a) is a top view, and FIG. 18(b) is a front view. As shown in FIGS. 18(a) and 18(b), the molding die assembly for use in the method according to the fifth embodiment comprises an upper die 26 and a lower die 27. The upper die 26 and the lower die 27 are adapted to define a cavity 28 therewithin when they are combined together. The lower die 27 is adapted to define a bottom of the cavity 28 when it is combined with the upper die 26. A positioning pin 26a is provided in one of four sidewalls of the upper die 26. The positioning pin 26a is adapted to be movable within the cavity 28 in a horizontal direction (in FIG. 18(a), in an upward-downward direction). In the fifth embodiment, the positioning pin 26a is comprised of a columnar-shaped metal bar having a diameter of 0.97 mm. Further, the positioning pin 26a is provided in the upper die 26 in such a manner that a distance between an axis of the positioning pin 26a and a bottom of the cavity 28 is 1.0 mm.

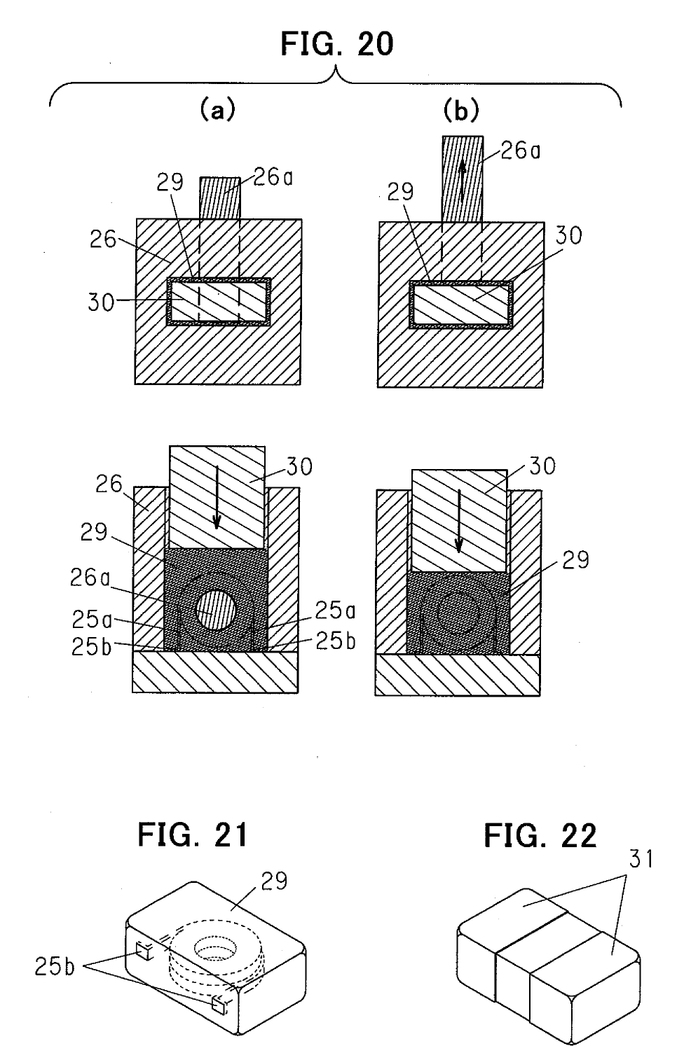

The molded coil production method according to the fifth embodiment will now be described. FIGS. 19(a) to 21 illustrate main steps of the method according to the fifth embodiment, wherein each of FIGS. 19(a) to 20(b) includes a top view on an upper side of the drawing sheet and a front view on a lower side of the drawing sheet. FIG. 22 is a perspective view showing a molded coil produced by the method according to the fifth embodiment.

In the first step illustrated in FIG. 19(a), the air-core coil 25 is set within the cavity 28, and then the molding die assembly is preheated at 180° C. Specifically the air-core coil 25 is set in such a manner that the positioning pin 26a is inserted into a hollow space of the air-core coil 25, and the bent ends 25b are located on the side of the bottom of the cavity 28. Thus, the air-core coil 25 is positioned at an intended position within the cavity 28.

In the next step illustrated in FIG. 19(b), a given weighted amount of moldable magnetic resin material 29 is input from an opening of the upper die 26 into the cavity 28 to cover over the air-core coil 25, and the moldable magnetic resin material 29 is molten by heat of the preheated molding die assembly. The moldable magnetic resin material 29 has the same composition as that of the moldable magnetic resin material used in the first to fourth embodiments.

In the next step illustrated in FIG. 20(a), a punch 30 is set at the opening of the upper die 26, and the moldable magnetic resin material 29 is pressurized using the punch 30 to a pressure of 5 kgf for 5 seconds. In this step, the extension direction of the lead-out portions 25a is aligned with a charging direction of the moldable magnetic resin material 29 (i.e., a pressurization direction of the punch 30), and therefore a displacement of the bent portions 25b is less likely to occur. Through this step, except a part of the cavity 28 occupied by the positioning pin 26a, the air-core coil 25 is adequately encapsulated with the moldable magnetic resin material 29. In the next step illustrated in FIG. 20(b), the pressurization by the punch 30 is interrupted to allow the punch 30 to be set in a free state, and, under this condition, the positioning pin 26a is moved horizontally to a retracted position where a distal edge surface thereof becomes flush with a lateral surface of the cavity 28 (see the top view of FIG. 20(b)), whereafter the moldable magnetic resin material 29 is re-pressurized using the punch 30 to a pressure of 10 kgf for 20 seconds (see the front view of FIG. 20(b)). Through this step, the moldable magnetic resin material 29 is charged into a part of the cavity 28 which has been occupied by the positioning pin 26a. Subsequently, the moldable magnetic resin material 29 is cured at 180° C. for 10 minutes.

In the next step illustrated in FIG. 21, a molded product obtained by curing the moldable magnetic resin material 29 is taken out of the molding die assembly. The molded product is subjected to sandblasting to remove burrs therefrom and allow a terminal end (bent ends 25b) of the air-core coil 25 to be exposed outside the molded product. Then, the molded product, except a portion for forming an external electrode, is coated with epoxy resin. Further, a self-bonding film bonded on the exposed bent ends 25b is removed by grinding, and an electrically-conductive resin is applied onto the molded body in such a manner that it is electrically connected to the air-core coil 25. Then, an external electrode 31 is formed on the molded product by plating. In the above manner, the molded coil as shown in FIG. 22 is produced.

### Sixth Embodiment

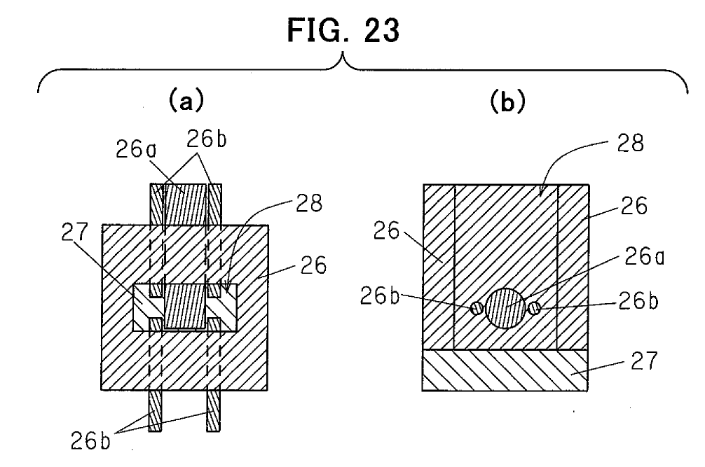

With reference to FIGS. 23(a) to 25(c), a molded coil production method according to a sixth embodiment of the present invention will be described. The method according to the sixth embodiment employs a molding die assembly having a positioning pin and a support pin each adapted to be moved within a cavity in a horizontal direction. The method according to the sixth embodiment is intended to produce a molded coil having the same configuration as that of the molded coil in the fifth embodiment, using the same air-core coil and moldable magnetic resin material as those used in the fifth embodiment. Thus, the method according to the sixth embodiment employs a common element to that in the fifth embodiment, and a detailed description about such a common element will be omitted.

A molding die assembly for use in the method according to the sixth embodiment will first be described. FIGS. 23(a) and 23(b) illustrate a molding die assembly for use in the method according to the sixth embodiment, wherein FIG. 23(a) is a top view, and FIG. 23(b) is a front view. As with the fifth embodiment, the molding die assembly for use in the method according to the sixth embodiment comprises an upper die 26 and a lower die 27. The upper die 26 and the lower die 27 are adapted to define a cavity 28 therewithin when they are combined together. The lower die 27 is adapted to define a bottom of the cavity 28 when it is combined with the upper die 26. A positioning pin 26a having the same structure as that of the positioning pin in the fifth embodiment is provided in one of four sidewalls of the upper die 26, in the same manner as that in the fifth embodiment. Further, four support pins 26b are provided in the upper die 26. In the sixth embodiment, each of the four support pins 26b is comprised of a columnar-shaped metal bar having a diameter of 0.4 mm. The four support pins 26b are arranged such that two of the support pins 26b are located on one side of opposing lateral surfaces of the cavity 20, and the remaining two support pins 26b are located on the other side. Each of the support pins 26b is adapted to be movable within the cavity 28 in a horizontal direction (in FIG. 23(a), in an upward-downward direction).

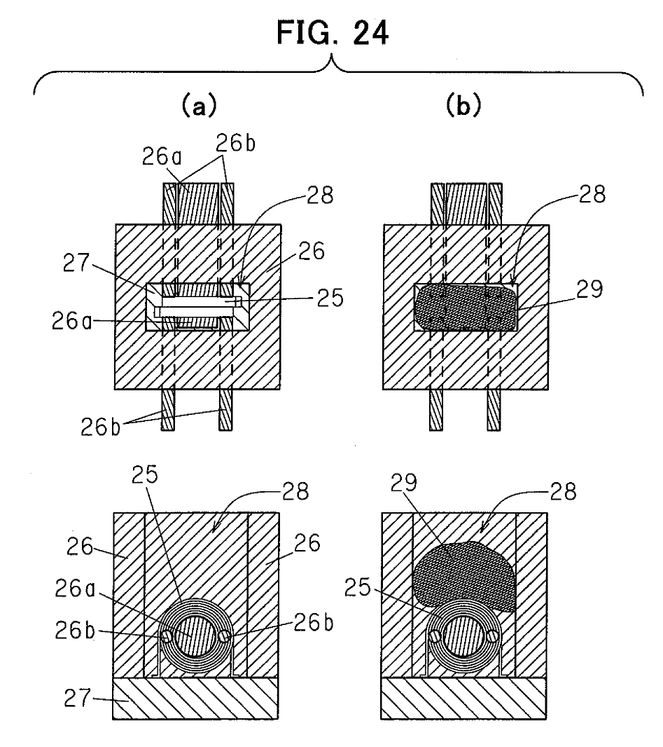

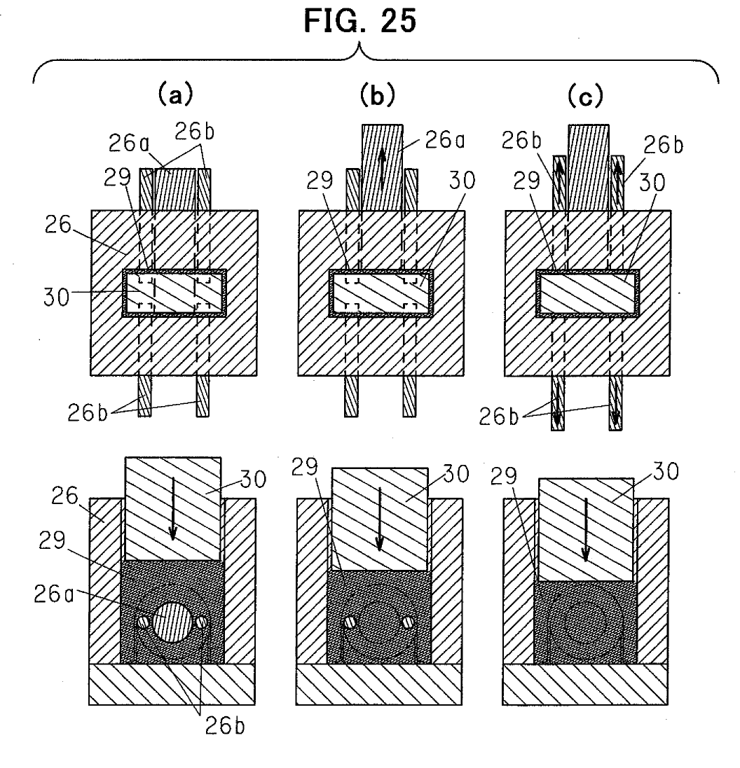

The molded coil production method according to the sixth embodiment will now be described. FIGS. 24(a) to 25(c) illustrate main steps of the method according to the sixth embodiment, wherein each of FIGS. 24(a) to 25(c) includes a top view on an upper side of the drawing sheet and a front view on a lower side of the drawing sheet.

In the first step illustrated in FIG. 24(a), the air-core coil 25 is set within the cavity 28, and then the molding die assembly is preheated at 180° C. Specifically, the air-core coil 25 is set in such a manner that the positioning pin 26a is inserted into the hollow space of the air-core coil 25, and the air-core coil 25 is clamped by the support pins 26b. The clamping by the support pins 26b makes it possible to enhance accuracy in thicknesswise position of the air-core coil 25 in a molded coil.

In the next step illustrated in FIG. 24(b), the moldable magnetic resin material 29 is input a in a given weighted amount from an opening of the upper die 26 into the cavity 28 to cover over the air-core coil 25, and the moldable magnetic resin material 29 is molten by heat of the preheated molding die assembly.

In the next step illustrated in FIG. 25(a), a punch 30 is set at the opening of the upper die 26, and the moldable magnetic resin material 29 is pressurized using the punch 30 to a pressure of 3 kgf for 5 seconds. In the next step illustrated in FIG. 25(b), the pressurization by the punch 30 is interrupted to allow the punch 30 to be set in a free state, and, under this condition, the positioning pin 26a is moved horizontally to a retracted position where a distal edge surface thereof becomes flush with a lateral surface of the cavity 28 (see the top view of FIG. 25(b)), whereafter the moldable magnetic resin material 29 is re-pressurized using the punch 30 to a pressure of 5 kgf for 5 seconds (see the front view of FIG. 25(b)). Through this step, the moldable magnetic resin material 29 is charged into a part of the cavity 28 which has been occupied by the positioning pin 26a. In the next step illustrated in FIG. 25(c), the pressurization by the punch 30 is interrupted to allow the punch 30 to be set in a free state, and, under this condition, each of the support pins 26b is moved horizontally to a retracted position where a distal edge surface thereof becomes flush with a lateral surface of the cavity 28 (see the top view of FIG. 25(c)), whereafter the moldable magnetic resin material 29 is re-pressurized using the punch 30 to a pressure of 10 kgf for 20 seconds (see the front view of FIG. 25(c)). Through this step, the moldable magnetic resin material 29 is charged into a part of the cavity 28 which has been occupied by the support pins 26b. Subsequently, the moldable magnetic resin material 29 is cured at 180° C. for 10 minutes.

Then, a molded product obtained by curing the moldable magnetic resin material 29 is taken out of the molding die assembly. The molded product is subjected to sandblasting to remove burrs therefrom and allow a terminal end of the air-core coil 25 to be exposed outside the molded product. Further, a self-bonding film bonded on the exposed end of the air-core coil 25 is removed by grinding, and an electrically-conductive resin is applied onto the molded body in such a manner that it is electrically connected to the air-core coil 25. Then, an external electrode is formed on the molded product by plating. In the above manner, an intended molded coil is produced.

### Seventh Embodiment

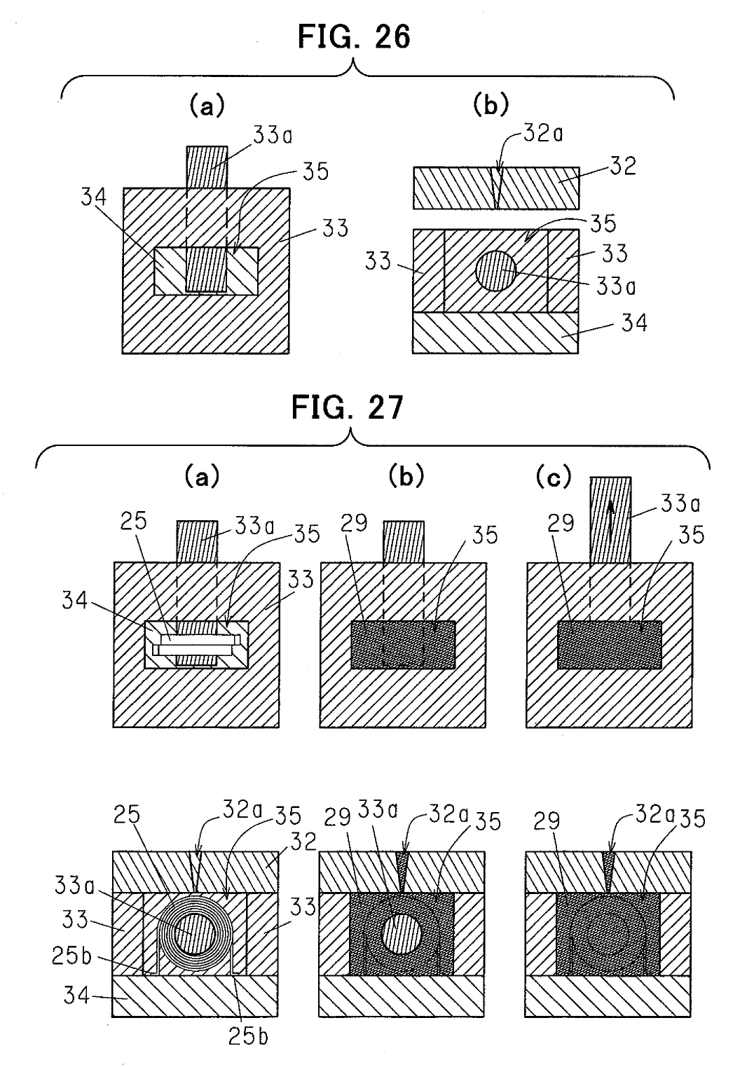

With reference to FIGS. 26(a) to 27(c), a molded coil production method according to a seventh embodiment of the present invention will be described. The method according to the seventh embodiment is intended to produce a molded coil having the same configuration as that of the molded coil in the fifth embodiment, by a transfer molding process using the same air-core coil and moldable magnetic resin material as those in the fifth embodiment. Thus, the method according to the seventh embodiment employs a common element to that in the fifth embodiment, and a detailed description about such a common element will be omitted.

A molding die assembly designed for a transfer molding process in the method according to the seventh embodiment will first be described. FIGS. 26(a) and 26(b) illustrate a molding die assembly for use in the method according to the seventh embodiment, wherein FIG. 26(a) is a top view, and FIG. 26(b) is a front view. As shown in FIGS. 26(a) and 26(b), the molding die assembly for use in the method according to the seventh embodiment comprises an upper die 32, an intermediate die 33 and a lower die 34. The upper die 32, the intermediate die 33 and the lower die 34 are adapted to define a cavity 35 therewithin when they are combined together. The lower die 34 is adapted to define a bottom of the cavity 35 when it is combined with the intermediate die 33.

The upper die 32 is provided with a pin-point gate 32a. The pin-point gate 32a is adapted to allow the moldable magnetic resin material brought into a molten state in a chamber pot (not shown) to be charged into the cavity 35 therethrough. A positioning pin 33a is provided in one of four sidewalls of the intermediate die 33. The positioning pin 33a is adapted to be movable within the cavity 35 in a horizontal direction (in FIG. 26(a), in an upward-downward direction), in the same manner as that in the fifth embodiment.

The molded coil production method according to the seventh embodiment will now be described. FIGS. 27(a) to 27(c) illustrate main steps of the method according to the seventh embodiment, wherein each of FIGS. 27(a) to 27(c) includes a top view on an upper side of the drawing sheet and a front view on a lower side of the drawing sheet.

In the first step illustrated in FIG. 27(a), the air-core coil 25 is set within the cavity 35, and then the upper die 32, the intermediate die 33 and the lower die 34 are fixed to each other, whereafter the molding die assembly is preheated at 180° C. Specifically, the air-core coil 25 is set in such a manner that the positioning pin 33a is inserted into the hollow space of the air-core coil 25, and the bent ends 25b are located on the side of a bottom of the cavity 35, in the same manner as that in the fifth embodiment. In the next step illustrated in FIG. 27(b), the moldable magnetic resin material 29 is injected from the pin-point gate 32a into the cavity 35 at a pressure of 100 kgf, and the pressure is held for 5 seconds.

In the next step illustrated in FIG. 27(c), the positioning pin 33a is moved horizontally to a retracted position where a distal edge surface thereof becomes flush with a lateral surface of the cavity 35 (see the top view in FIG. 27(c)), and then the moldable magnetic resin material 29 is pressurized to a pressure of 200 kgf and the pressure is held, so that the moldable magnetic resin material 29 is charged into a part of the cavity 35 which has been occupied by the positioning pin 33a (see the front view in FIG. 27(c)). Under this condition, the pressure is further held for 8 minutes to cure the moldable magnetic resin material 29.

A molded product obtained by curing the moldable magnetic resin material 29 is taken out of the molding die assembly. The molded product is subjected to sandblasting to remove burrs therefrom and allow a terminal end (bent ends 25b) of the air-core coil 25 to be exposed to a lateral surface of the molded product. Further, a self-bonding film bonded on the exposed end of the air-core coil 25 is removed by grinding, and an electrically-conductive resin is applied onto the molded body in such a manner that it is electrically connected to the air-core coil 25. Then, an external electrode is formed on the molded product by plating. In the above manner, an intended molded coil is produced.

### Eighth Embodiment

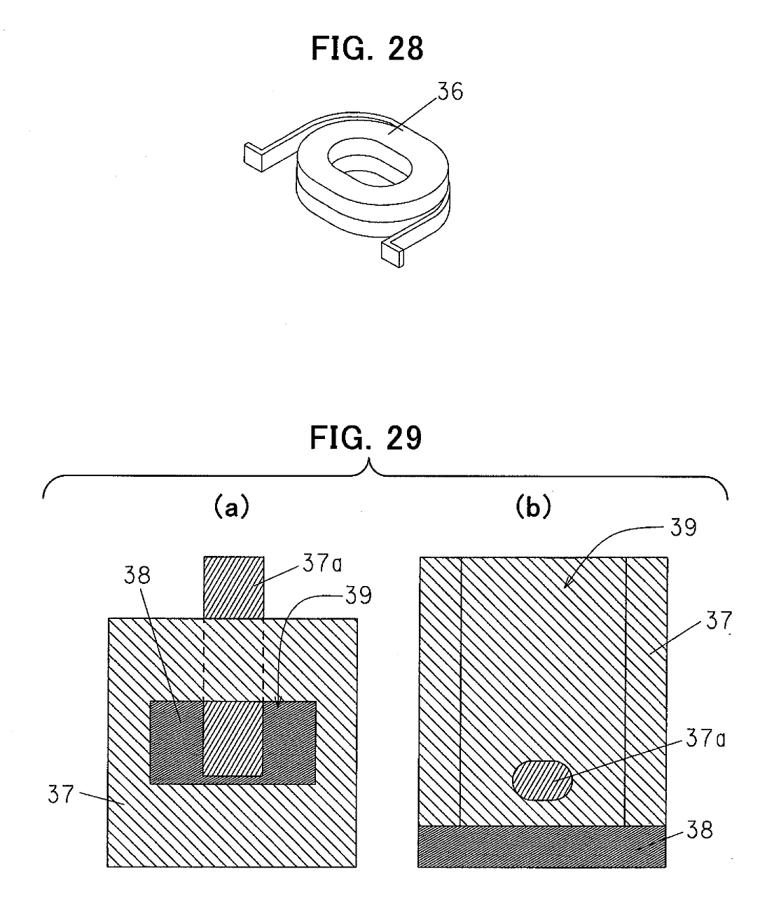

With reference to FIGS. 28 to 30b, a molded coil production method according to an eighth embodiment of the present invention will be described. The method according to the eighth embodiment employs a molding die assembly having a positioning pin adapted to be moved within a cavity in a horizontal direction, and an air-core coil having a non-generally circular shape. A moldable magnetic resin material for use in the method according to the eighth embodiment has the same composition as that of the moldable magnetic resin material used in the first to seventh embodiments. Further, in the eighth embodiment, a molded coil is produced through the same process as that in the fifth embodiment. Thus, the method according to the eighth embodiment employs a common element or process to that in the first to seventh embodiments, and a detailed description about such a common element or process will be omitted.

An air-core coil for use in the method according to the eighth embodiment will first be described. FIG. 28 is a perspective view showing an air-core coil 36 for use in the method according to the eighth embodiment. The air-core coil 36 is formed using the same rectangular wire as that used in the method according to the fourth embodiment. Specifically, the air-core coil 36 is formed by winding the rectangular wire by 12 turns in a lap winding manner through the use of the same core member as that used in the method according to the fourth embodiment, extending a pair of lead-out portions in the same direction, and bending respective terminal ends of the lead-out portions to form a pair of bent ends, as shown in FIG. 36.

A molding die assembly for use in the method according to the eighth embodiment will be described below. FIGS. 29(a) and 29(b) illustrate a molding die assembly for use in the method according to the eighth embodiment, wherein FIG. 29(a) is a top view, and FIG. 29(b) is a front view. As shown in FIGS. 29(a) and 29(b), the molding die assembly for use in the method according to the eighth embodiment comprises an upper die 37 and a lower die 38. The upper die 37 and the lower die 38 are adapted to define a cavity 39 therewithin when they are combined together The lower die 38 is adapted to define a bottom of the cavity 39 when it is combined with the upper die 37. A positioning pin 37a is provided in one of opposing sidewalls of the upper die 37. The positioning pin 37a is adapted to be moved to protrude toward the other sidewall, and further moved backwardly relative to the protruding direction (i.e., movable within the cavity 39 in a horizontal direction). In the eighth embodiment, the positioning pin 37a is comprised of a columnar-shaped metal bar having a diameter less than that of the core member by 20 μm, as with the positioning pin in the fourth embodiment. Further, the positioning pin 37a is provided in the upper die 37 in such a manner that a distance between an axis of the positioning pin 37a and a bottom of the cavity 39 is 1.0 mm.

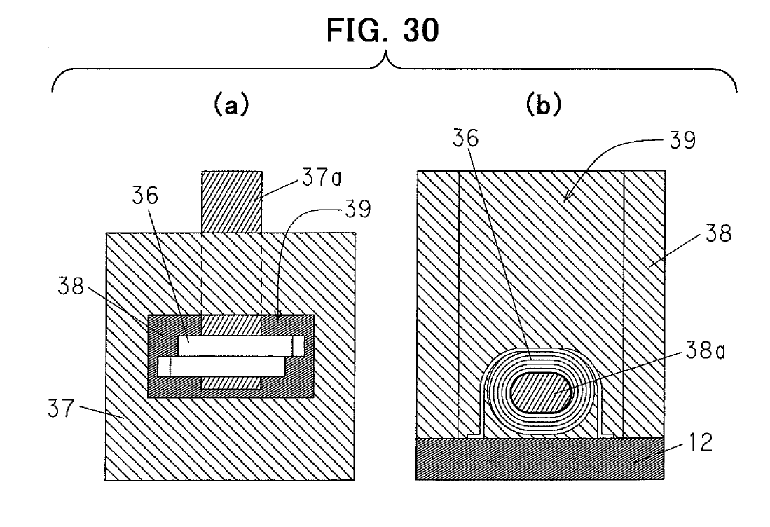

FIGS. 30(a) and 30(b) illustrate an arrangement of the air-core coil according to the eighth embodiment, wherein FIG. 30(a) is a top view, and FIG. 30(b) is a front view. The air-core coil 36 is set within the cavity 39, as shown in FIGS. 30(a) and 30(b). Then, a molded coil is produced according to the steps described in the fifth embodiment.

Preferred embodiments of the present invention have been shown and described. It is apparent to those skilled in the art that various changes and modifications may be made therein without departing from the spirit and scope thereof as set forth in appended claims.

For example, although the positioning pin in the first to eighth embodiments is formed in a columnar shape, it may be formed in any other suitable shape capable of positionally fixing the air-core coil without displacement, such as a prism shape or a ring shape. Further, the number of positioning pins is not limited to one, but a plurality of positioning pins may be used for positionally fixing the air-core coil. In the first to eighth embodiments, the support pin is formed in a columnar shape. Alternatively, the support pin may be formed in any other suitable shape, such as a prism shape. Further, the number of support pins and a position of the support pin may be appropriately selected according to an intended purpose.

Although the positioning pin in the first to eighth embodiments is moved to the retracted position thereof under a non-pressurized condition, it may be moved to the retracted position thereof under a pressurized condition. Differently, it is preferable that the support pin is moved to the retracted position thereof under a reduced pressure or under a non-pressurized condition. Further, the positioning pin and the support pin may be simultaneously moved to the respective retracted positions. However, this operation is likely cause positional deviation or deformation of the air-core coil due to an increase in movement of the moldable magnetic resin material. Thus, it is preferable to move the support pin after moving the positioning pin.

In the first to eighth embodiments, a rectangular wire is used as a wire of the air-core coil. Alternatively, a round wire may also be used. In the first to eighth embodiments, a novolac-type epoxy resin as a thermosetting resin is used as a resin in the moldable magnetic resin material. Alternatively, a polyimide resin as a thermosetting resin, or a thermoplastic resin, may also be used.

Although the molded coil production method according to each of the second and seventh embodiments has been described based on a transfer molding process, the method may also be implemented using an injection molding process. However, the transfer molding process and the injection molding process cause an increase in material loss. Thus, the compression molding process is advantageous to reduction in cost.

In the third embodiment, a phosphor-bronze plate is used for the external electrode. The external electrode serves as a means to allow the air-core coil to be held in midair within the cavity. Thus, the external electrode may be formed using a brass plate or any other suitable metal plate. Further, in the third embodiment, the external electrode is formed to have four support portions, two connection portions and four extension portions. However, the configuration (member, shape, position, etc.) of each of the portions may be appropriately adjusted depending on a configuration of an intended molded coil. Further, in the third embodiment, the molded coil is produced using a compression molding process. Alternatively, the molded coil may be produced using any other suitable plastic molding process, such as a transfer molding process or an injection molding process.

Although circular-shaped and oval-shaped air-core coils are used in the first to eighth embodiments, the present invention can be applied to an air-core coil having any other shape, such as a semicircular shape, a sector shape, an elliptical shape, a generally polygonal shape, or any combination thereof.

What is claimed is:

1. A method of producing, by using a plastic molding process, a molded coil having an air-core coil encapsulated with a moldable magnetic resin material prepared by kneading a magnetic powder and a resin, the method comprising the steps of:
preparing a molding die assembly including a plurality of dies adapted to define a cavity therewithin, a positioning pin and a support pin, each of the positioning pin and the support pin being adapted to be movable in a vertical direction within the cavity;
arranging the air-core coil within the cavity in such a manner that it is fixed relative to the cavity in a horizontal direction by the positioning pin, and held in midair by the support pin; and
charging the moldable magnetic resin material into the cavity and moving the positioning pin and the support pin to given positions thereof in a course of the charging.

2. The method as defined in claim 1, wherein the moldable magnetic resin material contains the magnetic powder in an amount of 60 volume % or more.

3. The method as defined in claim 1, wherein the air-core coil has a shape selected from the group consisting of a semicircular shape, a sector shape, an oval shape, an elliptical shape, a generally polygonal shape, and any combination thereof.

4. The method as defined in claim 1, wherein the plastic molding process is one selected from the group consisting of a compression molding process, a transfer molding process and an injection molding process.

5. The method as defined in claim 1, further comprising, during the step of charging the moldable magnetic resin material into the cavity, the steps of:
charging the moldable magnetic resin material into a part other than the part of the positioning pin and the support pin, followed by moving the positioning pin to the given position thereof;
charging the moldable magnetic resin material into a part of the positioning pin in an initial position thereof; and
moving the support pin to the given position thereof.

6. The method as defined in claim 5, further comprising, during the step of charging the moldable magnetic resin material into the cavity, the steps of:
pressurizing the charged moldable magnetic resin material at a pressure less than the immediately prior pressure, or placing the charged moldable magnetic resin material in a non-pressurized state;
moving the support pin to the given position thereof; and
subsequent to moving the support pin, re-pressurizing the charged moldable magnetic resin material.

7. The method as defined in claim 5, wherein the moldable magnetic resin material contains the magnetic powder in an amount of 60 volume % or more.

8. The method as defined in claim 5, wherein the air-core coil has a shape selected from the group consisting of a semicircular shape, a sector shape, an oval shape, an elliptical shape, a generally polygonal shape, and any combination thereof.

9. The method as defined in claim 5, wherein the plastic molding process is one selected from the group consisting of a compression molding process, a transfer molding process and an injection molding process.

10. A method of producing, by using a plastic molding process, a molded coil having an air-core coil encapsulated with a moldable magnetic resin material having a magnetic powder dispersed thereover, the method comprising the steps of:
attaching an external electrode to the air-core coil;
preparing a molding die assembly including a plurality of dies adapted to define a cavity therewithin, and a positioning pin adapted to be movable in a vertical direction within the cavity;
arranging the air-core coil within the cavity in such a manner that it is fixed relative to the cavity in a horizontal direction by the positioning pin, and held in midair by the external electrode; and
charging the moldable magnetic resin material into the cavity and moving the positioning pin to a given position thereof in a course of the charging.

11. The method as defined in claim 10, wherein the moldable magnetic resin material contains the magnetic powder in an amount of 60 volume % or more.

12. The method as defined in claim 10, wherein the air-core coil has a shape selected from the group consisting of a semicircular shape, a sector shape, an oval shape, an elliptical shape, a generally polygonal shape, and any combination thereof.

13. The method as defined in claim 10, wherein the plastic molding process is one selected from the group consisting of a compression molding process, a transfer molding process and an injection molding process.

14. A method of producing, by using a plastic molding process, a molded coil having an air-core coil encapsulated with a moldable magnetic resin material prepared by kneading a mixture of a magnetic powder and a resin, the method comprising the steps of:
preparing a molding die assembly including a plurality of dies, a cavity defined by the dies, and a positioning pin adapted to be movable in a horizontal direction within the cavity;
arranging the air-core coil at a given position within the cavity by use of the positioning pin; and
charging the moldable magnetic resin material into the cavity and moving the positioning pin to a given position thereof in a course of the charging.

15. The method as defined in claim 14, further comprising, during the step of charging the moldable magnetic resin material into the cavity, the step of charging the moldable magnetic resin material into the cavity in a vertical direction.

16. The method as defined in claim 14, wherein the moldable magnetic resin material contains the magnetic powder in an amount of 60 volume % or more.

17. The method as defined in claim 14, wherein the air-core coil has a shape selected from the group consisting of a semicircular shape, a sector shape, an oval shape, an elliptical shape, a generally polygonal shape, and any combination thereof.

18. The method as defined in claim 14, wherein the plastic molding process is one selected from the group consisting of a compression molding process, a transfer molding process and an injection molding process.

19. The method as defined in claim 14, wherein the molding die assembly further includes a plurality of support pins each adapted to be movable in a horizontal or vertical direction within the cavity, the method further comprising the steps of:
arranging the air-core coil at the given position within the cavity by use of the support pins in cooperation with the positioning pin; and
moving each of the support pins to a given retracted position thereof in the course of the charging.

20. The method as defined in claim 19, further comprising, during the step of charging the moldable magnetic resin material into the cavity, the steps of:
charging the moldable magnetic resin material into a part other than the part of the positioning pin and the support pin, followed by moving the positioning pin to the given position thereof;
charging the moldable magnetic resin material into a part of the positioning pin in an initial position thereof; and
moving the support pin to the given position thereof.

21. The method as defined in claim 19, further comprising, during the step of charging the moldable magnetic resin material into the cavity, the steps of:
pressurizing the charged moldable magnetic resin material at a pressure less than the immediately prior pressure, or placing the charged moldable magnetic resin material in a non-pressurized state;
moving the support pin to the given position thereof; and
subsequent to moving the support pin, re-pressurizing the charged moldable magnetic resin material.

22. The method as defined in claim 19, wherein the moldable magnetic resin material contains the magnetic powder in an amount of 60 volume % or more.

23. The method as defined in claim 19, wherein the air-core coil has a shape selected from the group consisting of a semicircular shape, a sector shape, an oval shape, an elliptical shape, a generally polygonal shape, and any combination thereof.

24. The method as defined in claim 19, wherein the plastic molding process is one selected from the group consisting of a compression molding process, a transfer molding process and an injection molding process.
